(19) United States
(12) Patent Application Publication
(10) Pub. No.: US 2019/0048288 A1
(43) Pub. Date: Feb. 14, 2019

(54) METHOD OF LAUNDERING FABRICS

(71) Applicant: The Procter & Gamble Company, Cincinnati, OH (US)

(72) Inventors: Audrey Claire Francoise BOUNIOL, Brussels (BE); Nea Janette LINTULA, Brussels (BE); Jean-Pol BOUTIQUE, GEMBLOUX (BE); Karel Jozef Maria DEPOOT, Anzegem-Vichte (BE)

(21) Appl. No.: 16/059,132

(22) Filed: Aug. 9, 2018

(30) Foreign Application Priority Data
Aug. 11, 2017 (EP) 17185932.5

(51) Int. Cl. C11D 3/00; C11D 3/22; C11D 3/20; C11D 3/30; C11D 3/37; C11D 1/14; C11D 1/22; C11D 1/722; C11D 11/00; C11D 17/04

(52) U.S. Cl. CPC C11D 3/001; C11D 3/222; C11D 3/2075; C11D 3/30; C11D 3/3749; C11D 17/044; C11D 1/146; C11D 1/22; C11D 1/722; C11D 11/0017; C11D 3/2093

(57) ABSTRACT

A method of laundering fabrics involving the steps of diluting a water-soluble unit dose article to create a main wash to treat fabrics followed by treatment of said fabrics in a second subsequent rinse liquor formed by dilution of a softening composition.

### FIELD OF THE INVENTION

The present invention is to a method of laundering fabrics involving the steps of diluting a water-soluble unit dose article to create a main wash to treat fabrics followed by treatment of said fabrics in a second subsequent rinse liquor formed by dilution of a softening composition.

### BACKGROUND OF THE INVENTION

During the laundry wash operation, consumers like to both clean fabrics and impart fabric softening benefits on them. This is achieved by washing the fabric in the main wash step using a laundry detergent and then adding a fabric softening active to the fabrics during the subsequent rinse step.

However, there is a tendency to both overdose the laundry detergent and the laundry softener. This practice is wasteful as it wastes resources and energy and so is environmentally unfriendly.

Without wishing to be bound by theory, consumers tend to overdose the laundry detergent as they feel such practice is necessary to ensure fabrics are sufficiently cleaned. A similar practice is evident with respect to the fabric softener to ensure sufficient softening benefit. More particularly it is believed that part of the softening active present in the rinse liquor is not deposited on the fabric during the wash operation and is drained away together with the rinsing water. This compromises the softness performance on the fabric and also has a negative effect on environmental sustainability.

Therefore, there is a need in the art for a method of laundering fabrics that enables the reduction in overdosing of laundry detergent and fabric softening active during the wash, preferably to enable a more environmentally friendly wash operation. More preferably, the method allows for improved deposition of the softening active on the fabrics during a rinse cycle and as such enables a reduction in overdosing of fabric softening active during the wash, and preferably enabling a more environmentally friendly wash operation

It was surprisingly found that the method of the present invention overcame this problem. By ensuring the laundry detergent is formulated as a unit dose article, the issue of over dosing of the laundry detergent is minimized. This is because the unit dose article acts as a self-contained single dose sufficient for a single wash operation and so the consumer is discouraged from overdosing the laundry detergent.

In addition, the formulation of a cationic polysaccharide polymer in the unit dose article, which is added during the main wash step was surprisingly found to improve the softening performance of the softening active in the rinse step, meaning less softening active is needed to achieve desired softening of the fabrics.

### SUMMARY OF THE INVENTION

A first aspect of the present invention is a method of laundering fabrics comprising the steps of;
a. providing a water-soluble unit dose article, wherein the water-soluble unit dose article comprises a water-soluble film and a laundry detergent composition, wherein the laundry detergent composition comprises a non-soap anionic surfactant, a cationic polysaccharide polymer and less than 10% by weight of the laundry detergent composition of a fatty acid, a neutralised fatty acid soap or a mixture thereof;
b. contacting the water-soluble unit dose article with sufficient water to dilute the laundry detergent composition by a factor of between 300 and 3000 fold to create a main wash liquor and contacting the fabrics to be laundered with the wash liquor;
c. washing the fabrics to be washed in the main wash liquor, and then separating the fabrics and said main wash liquor from one another;
d. providing a fabric softening composition, wherein the fabric softening composition comprises a softening active selected from the group consisting of quaternary ammonium compounds, amines, fatty esters, sucrose esters, silicones, dispersible polyolefins, polysaccharides, fatty acids, softening oils, polymer latexes, softening clays and combinations thereof, preferably wherein the fabric softening active is selected from the group consisting of quaternary ammonium compounds and mixtures thereof, more preferably ester quats, most preferably wherein the fabric softening active is selected from the group consisting of diester quats, more preferably Diethylester Dimethyl Ammonium Chloride;
e. contacting the fabric softening composition with sufficient water to dilute the fabric softening composition by a factor of between 300 and 3000 fold to create a rinse liquor and contacting the fabrics from step c with the rinse liquor;
f. rinsing the fabrics in the rinse liquor, and then separating the fabrics and said rinse liquor from one another;
g. drying the fabrics.

### BRIEF DESCRIPTION OF THE DRAWINGS

FIG. 1 is a water-soluble unit dose article according to the present invention.

### DETAILED DESCRIPTION OF THE INVENTION

### The Method

The present invention discloses a method of laundering fabrics.

The method comprises the steps of;
a. providing a water-soluble unit dose article.
   The water-soluble unit dose article is described in more detail below.
b. contacting the water-soluble unit dose article with sufficient water to dilute the laundry detergent composition by a factor of between 300 and 3000 fold to create a main wash liquor and contacting the fabrics to be laundered with the wash liquor.

The fabric to be laundered may be any suitable fabric. By fabric we preferably mean a textile or cloth comprising a network of natural or synthetic fibers. Those skilled in the art will be aware of suitable fabrics. The fabric may be selected from cotton, polyester, cotton/polyester blends or a mixture thereof, preferably cotton. The fabric may comprise a stain, soil or mixture thereof to be removed. Those skilled in the art will be aware of suitable stains or soils to be removed.

Those skilled in the art will know how to make the main wash liquor. Without wishing to be bound by theory, addition of the water-soluble unit dose article to water will cause the water-soluble film to dissolve and release the laundry detergent composition into the water creating the main wash liquor.

The main wash liquor can be created automatically in the drum of an automatic washing machine or can be made in a manual wash operation. When made in the drum of an automatic washing machine, traditionally, the fabrics to be washed and the water-soluble unit dose article are added to the drum and the door of the washing machine closed. The washing machine then automatically adds water to the drum to create the main wash liquor.
c. washing the fabrics to be washed in the main wash liquor, and then separating the fabric and said main wash liquor from one another.

Those skilled in the art will be aware of suitable ways to wash the fabrics in the main wash liquor. The fabrics may be wash in the main wash liquor in an automatic washing machine process or in a manual wash operation or a mixture thereof. Preferably the fabrics are washed in an automatic washing machine process.

Preferably the main wash liquor may comprise between 1 L and 64 L, preferably between 2 L and 32 L, more preferably between 3 L and 20 L of water.

Preferably, the main wash liquor is at a temperature of between 5° C. and 90° C., preferably between 10° C. and 60° C., more preferably between 12° C. and 45° C., most preferably between 15° C. and 40° C.

Preferably, washing the fabrics in the main wash liquor takes between 5 minutes and 50 minutes, preferably between 5 minutes and 40 minutes, more preferably between 5 minutes and 30 minutes, even more preferably between 5 minutes and 20 minutes, most preferably between 6 minutes and 18 minutes to complete.

Preferably, the main wash liquor and the rinse wash liquor independently comprises between 1 kg and 20 kg, preferably between 3 kg and 15 kg, most preferably between 5 and 10 kg of fabrics. The rinse wash liquor is described in more detail below.

The main wash liquor may comprise water of any hardness preferably varying between 0 gpg to 40 gpg. A lower water hardness is termed soft water whereas a higher water hardness is termed hard water.

The fabrics and the wash liquor are separated from one another following washing of the fabrics. Such separation may involve removing the fabrics from the wash liquor, or draining the wash liquor away from the fabrics. In an automatic washing machine operation it is preferred that the wash liquor is draining away from the fabrics. In the avoidance of doubt, some of the wash liquor may remain soaked into the fabrics following separation of the fabrics and the main wash liquor, i.e. the fabrics remain wet. With respect to the present invention the fabrics and wash liquor are deemed separated from one another once the fabric is separate from the main volume of the wash liquor or the mina volume of the wash liquor has been drained away, despite some residual wash liquor possibly remaining soaked into the fabrics.
d. providing a fabric softening composition,

The fabric softening composition is described in more detail below.
e. contacting the fabric softening composition with sufficient water to dilute the fabric softening composition by a factor of between 300 and 3000 fold to create a rinse liquor and contacting the fabrics from step c with the rinse liquor.

Those skilled in the art will know how to make the rinse liquor. Without wishing to be bound by theory, the fabric softening composition is dispersed in the water to create the rinse liquor.

The rinse liquor can be created automatically in the drum of an automatic washing machine or can be made in a manual wash operation. When made in the drum of an automatic washing machine, traditionally, the fabrics from step c remain in the drum of the washing machine following draining of the main wash liquor. The washing machine then automatically doses the softening composition and further water into the drum containing the fabrics to create the rinse liquor comprising the fabrics. Preferably, the fabrics from step c are not removed from the drum of the washing prior to create of the rinse liquor. Preferably, once the main wash liquor has been drained away the washing machine creates the rinse liquor within 30 minutes, preferably within 20 minutes, more preferably within 10 minutes, most preferably within 5 minutes of removal of the main wash liquor.
f. rinsing the fabrics in the rinse liquor, and then separating the fabrics and said rinse liquor from one another.

Those skilled in the art will be aware of suitable ways to rinse the fabrics in the rinse liquor. The fabrics may be rinsed in an automatic washing machine process or in a manual rinse operation or a mixture thereof. Preferably the fabrics are rinsed in an automatic washing machine process.

Preferably the rinse liquor may comprise between 1 L and 64 L, preferably between 2 L and 32 L, more preferably between 3 L and 20 L of water.

Preferably, the rinse liquor is at a temperature of between 5° C. and 30° C., preferably between 5° C. and 25° C., more preferably between 5° C. and 20° C., most preferably between 5° C. and 15° C.

Preferably, rinsing the fabrics in the rinse liquor takes between 1 minute and 30 minutes, preferably between 2 minutes and 25 minutes, more preferably between 3 minutes and 20 minutes, most preferably between 5 minutes and 15 minutes to complete.

Preferably, the rinse liquor comprises between 1 kg and 20 kg, preferably between 3 kg and 15 kg, most preferably between 5 and 10 kg of fabrics.

The rinse liquor may comprise water of any hardness preferably varying between soft 0 gpg to 40 gpg. A lower water hardness is termed soft water whereas a higher water hardness is termed hard water.

The fabrics and the rinse liquor are separated from one another following washing of the fabrics. Such separation may involve removing the fabrics from the rinse liquor, or draining the rinse liquor away from the fabrics. In an automatic washing machine operation it is preferred that the rinse liquor is draining away from the fabrics. In the avoidance of doubt, some of the rinse liquor may remain soaked into the fabrics following separation of the fabrics and the rinse liquor, i.e. the fabrics remain wet. With respect to the present invention the fabrics and rinse liquor are deemed separated from one another once the fabric is separate from the main volume of the rinse liquor or the main volume of the rinse liquor has been drained away, despite some residual rinse liquor possibly remaining soaked into the fabrics.
g. drying the fabrics.

Those skilled in the art will be aware of suitable means to dry the fabrics. The fabrics may be dried on a line at room temperature, in an automatic drying machine or a mixture thereof. Those skilled in the art will know at what point the fabrics are deemed dry as opposed to wet.

### Water-Soluble Unit Dose Article

The water-soluble unit dose article comprises a water-soluble film and a laundry detergent composition. The laundry detergent composition and the water-soluble film are described in more detail below.

The water-soluble unit dose article comprises the water-soluble film shaped such that the unit-dose article comprises at least one internal compartment surrounded by the water-soluble film, and wherein the laundry detergent composition is present within said compartment. The unit dose article may comprise a first water-soluble film and a second water-soluble film sealed to one another such to define the internal compartment. The water-soluble unit dose article is constructed such that the laundry detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments. The compartments may be arranged in superposed orientation, i.e. one positioned on top of the other. In such an orientation, the unit dose article will comprise three films, top, middle and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the laundry detergent composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

The water-soluble unit dose article may comprise at least two internal compartments, wherein the liquid laundry detergent composition is comprised in at least one of the compartments, preferably wherein the unit dose article comprises at least three compartments, wherein the detergent composition is comprised in at least one of the compartments.

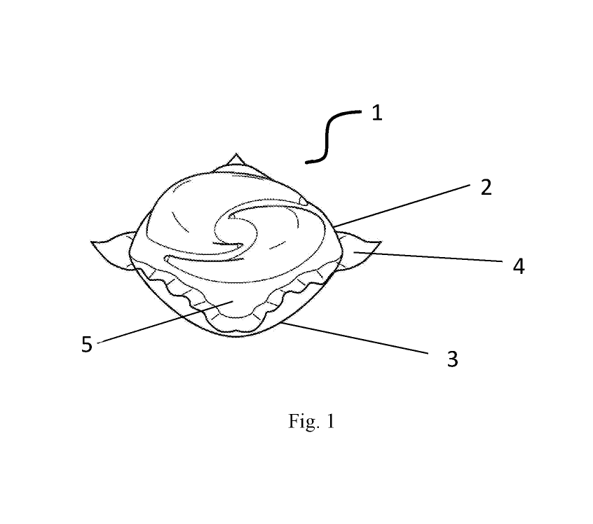

FIG. 1 discloses a water-soluble unit dose article (1) according to the present invention. The water-soluble unit dose article (1) comprises a first water-soluble film (2) and a second water-soluble film (3) which are sealed together at a seal region (4). The laundry detergent composition (5) is comprised within the water-soluble soluble unit dose article (1).

### Water-Soluble Film

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers and/or copolymers can also be used as the pouch material, especially mixtures of polyvinylalcohol polymers and/or copolymers, especially mixtures of polyvinylalcohol homopolymers and/or anionic polyvinylalcohol copolymers preferably selected from sulphonated and carboxylated anionic polyvinylalcohol copolymers especially carboxylated anionic polyvinylalcohol copolymers. Most preferably the water soluble film comprises a blend of a polyvinylalcohol homopolymer and a carboxylated anionic polyvinylalcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area.

The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Laundry Detergent Composition

The laundry detergent composition is a liquid, a powder or a mixture thereof, preferably a liquid laundry detergent composition.

The solid laundry detergent composition may comprise solid particulates or may be a single homogenous solid. Preferably, the solid laundry detergent composition comprises particles. This means the solid laundry detergent composition comprises individual solid particles as opposed to the solid being a single homogenous solid. The particles may be free-flowing or may be compacted, preferably free-flowing.

The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as powders, tablets or granules.

The laundry detergent composition comprises a non-soap anionic surfactant. The laundry detergent composition may comprise up to 50%, preferably between 5% and 50%, more preferably between 7.5% and 45%, even more preferably between 10% and 40%. The laundry detergent composition may comprise between 12% and 37%, preferably between 15% and 30% by weight of the laundry detergent composition of the non-soap anionic surfactant.

Preferably, the non-soap anionic surfactant comprises linear alkylbenzene sulphonate, alkoxylated alkyl sulphate or a mixture thereof, more preferably a mixture thereof wherein the weight ratio of linear alkylbenzene sulphonate to alkoxylated alkyl sulphate preferably the weight ratio of linear alkylbenzene sulphonate to ethoxylated alkyl sulphate is from 1:2 to 20:1, preferably from 1.1:1 to 15:1, more preferably from 1.2:1 to 10:1, even more preferably from 1.3:1 to 5:1, most preferably from 1.4:1 to 3:1.

The weight ratio of linear alkylbenzene sulphonate to ethoxylated alkyl sulphate may be from 1:10 to 20:1, preferably from 1:7 to 3:1, more preferably from 1:5 to 1.5:1.

The laundry detergent composition comprises a cationic polysaccharide polymer. The laundry detergent composition may comprise between 0.05% and 10%, preferably between 0.1% and 5%, more preferably between 0.2% and 3%, most preferably between 0.25% and 1% by weight of the laundry detergent composition of the cationic polysaccharide polymer.

Preferably, the cationic polysaccharide polymer is selected from cationically modified hydroxyethyl cellulose, cationically modified hydroxypropyl cellulose, cationically and hydrophobically modified hydroxyethyl cellulose, cationically and hydrophobically modified hydroxypropyl cellulose, or a mixture thereof, more preferably cationically modified hydroxyethyl cellulose, cationically and hydrophobically modified hydroxyethyl cellulose, or a mixture thereof.

Preferably, the cationic polysaccharide is in particulate form, preferably wherein the particulate cationic polysaccharide has an average D90 diameter of less than 300 microns, more preferably less than 200 microns, even more preferably less than 150 microns. Without wishing to be bound by theory, formulation of the cationic polysaccharide in particulate form has the added benefit of minimizing interaction of the cationic polysaccharide with the water-soluble film. Such interaction can retard the dissolution of both the film and the cationic polysaccharide.

The laundry detergent composition comprises less than 10% by weight of the laundry detergent composition of a fatty acid, a neutralised fatty acid soap or a mixture thereof. Preferably, the laundry detergent composition comprises less than 8%, more preferably less than 5%, most preferably between 1% and 5% by weight of the laundry detergent composition of fatty acid, neutralised fatty acid soap or a mixture thereof. Without wishing to be bound by theory, it is preferred to carefully control fatty acid and neutralized fatty acid soap levels. Whilst some fatty acid or neutralized fatty acid soap is preferred in order to neutralize water hardness, too much fatty acid, fatty acid soap or a mixture thereof can cause salt formation on the fabrics and deactivate the cationic polysaccharide ahead of use in the rinse step.

Preferably, the laundry detergent composition comprises between 0% and 9.5%, preferably between 0.01% and 9%, more preferably between 0.1% and 7%, even more preferably between 1% and 5%, most preferably between 1 and 3% by weight of the liquid laundry detergent composition of a fatty alcohol ethoxylate non-ionic surfactant.

The laundry detergent composition may comprise a further cleaning or care polymer, preferably wherein the cleaning or care polymer is selected from an ethoxylated polyethyleneimine, alkoxylated polyalkyl phenol, an amphiphilic graft copolymer, a polyester terephthalate, a carboxymethylcellulose or a mixture thereof.

The laundry detergent composition may also comprise other common detergent ingredients. Those other laundry detergent ingredients may be selected from bleach, bleach catalyst, dye, hueing agents, surfactants, solvents, dye transfer inhibitors, chelants, enzymes, perfumes, encapsulated perfumes, perfume delivery agents, suds suppressor, brighteners, polycarboxylates, structurants, anti-oxidants, deposition aids and mixtures thereof. Those skilled in the art will be aware of suitable common ingredients.

Preferably, the laundry detergent is diluted such that the main wash liquor comprises between 0.1 ppm and 100 ppm preferably between 0.5 ppm and 50 ppm, more preferably between 1 ppm and 20 ppm, of the cationic polysaccharide polymer.

Preferably, the laundry detergent is diluted such that the main wash liquor comprises between 10 ppm and 1000 ppm, preferably between 50 ppm and 900 ppm, more preferably between 100 ppm and 800 ppm of a non-soap anionic surfactant.

Preferably, the laundry detergent is diluted such that the main wash liquor comprises less than 300 ppm, preferably between 5 ppm and 250 ppm, more preferably between 10 ppm and 200 ppm of fatty acid, neutralised fatty acid soap, or a mixture thereof.

### Fabric Softening Composition

Preferably, the softening composition comprises between 2% and 25%, preferably between 4% and 20%, more preferably between 5% and 15%, most preferably between 5% and 13% by weight of the softening composition of the softening active.

Preferably, the fabric softening composition comprises a softening active selected from the group consisting of quaternary ammonium compounds, amines, fatty esters, sucrose esters, silicones, dispersible polyolefins, polysaccharides, fatty acids, softening oils, polymer latexes, softening clays and combinations thereof, preferably wherein the fabric softening active is selected from the group consisting of quaternary ammonium compounds and mixtures thereof, more preferably ester quats, most preferably wherein the fabric softening active is selected from the group consisting of diester quats, more preferably Diethylester Dimethyl Ammonium Chloride (DEEDMAC).

Preferably, the softening composition is diluted such that the rinse liquor comprises between 1 ppm and 500 ppm, preferably between 10 ppm and 400 ppm, most preferably between 20 ppm and 300 ppm of the softening active.

The fabric softening composition preferably further comprises perfume or perfume capsule technology, aiming at delivering scent to the treated fabrics. The fabric softening composition may comprise other common ingredients used in fabric softening compositions. Those skilled in the art will be aware of such common ingredients.

The present invention may be used to improve the deposition or performance of other materials present in the softening composition, for example perfume materials, or perfume capsules.

### Method of Making

Those skilled in the art will be aware of methods to make the water-soluble unit dose article, the laundry detergent composition and the fabric softening composition of the present invention using known methods in the art.

### Examples

The impact of presence versus absence of a cationic hydroxyethylcellulose (CatHEC) according to the present invention in the main wash has been assessed on the deposition efficacy hence softness performance of a diethylesterdimethylammonium-chloride (DEEDMAC) diesterquat softening active added during the subsequent rinse cycle.

### Main Wash Detergent Composition:

| | Comparative | Comparative |
|---|---|---|
| | Example A and | Example B and |
| | C (WT %) | Example A (WT %) |
| HLAS anionic surfactant | 14.15 | 14.15 |
| HAE3S (C24AE3S) anionic | 13.12 | 13.12 |
| surfactant | | |
| C24AE7 nonionic surfactant | 2.99 | 2.99 |
| Citric acid | 0.94 | 0.94 |
| Palm Kernel Fatty acid | 3.88 | 3.88 |
| HEDP chelant | 2.31 | 2.31 |
| Ethoxylated | 1.62 | 1.62 |
| polyethyleneimine | | |
| (PEI600EO20)* | | |
| Amphiphilic graft polymer** | 1.99 | 1.99 |
| Carboxymethylcellulose | 0.49 | 0.49 |
| Texcare SRA300 | 0.32 | 0.32 |
| Polymer PK ex Dow | — | 0.48 |
| (Cationic polysaccharide) | | |
| Brightener 49 | 0.45 | 0.45 |
| Hueing dye | 0.02 | 0.02 |
| Monoethanolamine | 7.83 | 7.83 |
| Water | 9.16 | 9.16 |
| 1,2 Propanediol | 21.29 | 19.99 |
| Glycerine | 7.79 | 7.79 |
| DiPropyleneGlycol | 7.55 | 7.55 |
| Minors (preservatives, | Balance | Balance |
| antioxidant, anti-foam, | to 100% | to 100% |
| perfume, dye Hydrogenated | | |
| Castor Oil structurant, | | |
| protease & amylase enzyme, | | |
| processing aids) | | |

*ethoxylated polyethyleneimine having an average degree of ethoxylation of 20 per EO chain and a polyethyleneimine backbone with MW of about 600
**polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains

*ethoxylated polyethyleneimine having an average degree of ethoxylation of 20 per EO chain and a polyethyleneimine backbone with MW of about 600
**polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains

### Fabric Enhancer Composition:

| Ingredient | WT % |
|---|---|
| DEEDMAC | 9.3% |
| Perfume | 2.4% |
| Water | 87% |
| Minors | Balance to 100% |

### Test Methods:

### Wash Process:

10 pieces of 100% cotton terry towels (size: 30 cm×30 cm) were washed together with 10 pieces of 50% cotton/50% polyester knitted swatches (size: 30 cm×30 cm−K7422) and 80% cotton/20% polyester ballast load (total weight of fabric in the wash: 2.7 kg) with 25.7 g of the formulations tabulated above in a top loading Kenmore 600 L washing machine on Heavy Duty cycle (32° C., wash time: 12 minutes, 64 Litres of 8 gpg water). The fabrics were consequently rinsed for 3 minutes in presence (Comparative Example C-Example A)/absence (Comparative Example A & B) of 25.5 g of the Fabric Enhancer composition tabulated above (20° C., rinse time: 3 minutes, 64 Litres of 8 gpg water) and tumble dried.

### Fabric to Fabric Friction Measurement:

The 100% cotton terry towel tracers were equilibrated for at least 5 hours in a room with constant temperature (23° C.) and humidity (55% relative humidity). The fabric to fabric kinetic friction coefficient was measured in the same room using a Thwing-Albert Friction Peel Tester with a 2.5 kg load cell and a crosshead height of 25 mm A first piece of fabric was laid on the sample stage of the instrument, and a second piece of the same fabric (11.43 cm×6.35 cm) was attached to a 200 g clamping sled attached to the load cell and placed on the surface of the first piece of fabric. The Friction Peel Tester is programmed to move the second piece of fabric (on the clamping sled) over the first piece of fabric (on the sample stage) at a speed of 20 cm/min for 20 seconds. As the fabrics move over each other the software records the frictional force experienced by the fabric on the clamping sled. The terry towel tracers are placed on the instrument to be measured against the grain.

The kinetic friction coefficient (referred to as “KCoF”) is derived by taking the average force of the last 10 seconds of the measurement (kinetic section) divided by the normal force exerted during the measurement. This kinetic friction coefficient is used as a measure of softness. A low kinetic friction coefficient means less friction, and so better softness. The average friction result of the 10 terry towels is reported below.

### Diesterquat Deposition Measurement:

Concentrations of DEEDMAC diesterquat material extracted from fabric after the wash test were analyzed by Hydrophilic interaction liquid chromatography/tandem mass spectrometry (HILIC/MS/MS) analysis, employing multiple-reaction monitoring (MRM).

The DEEDMAC diesterquat raw material was used to prepare working standards to generate a calibration curve. This curve covered a working standard concentration range of 13.2-to-1644 ng/mL, which translates into 12.8-1596 μg/g (ppm) for the active diesterquat deposited on fabric. A labelled internal standard with deuterium was used to correct for matrix effects.

The amount of deposited DEEDMAC diesterquat has been defined by cross-comparing the measurement on the extracted DEEDMAC diesterquat material versus the generated calibration curve. The average result of the 10 cotton terry towels has been reported.

| | |
|---|---|
| REAGENTS USED | |
| DEEDMAC Diesterquat d3 | Hard Tallow DEEDMac d6, Rewoquat V3283 |
| deuterated internal standard (IS) | Lot#: M919388Ex-002, Manufacturer: Evanik Degussa |
| DEEDMAC Diesterquat raw | REWOQUAT CI-DEEDMAC, Material No. 99057480, |
| material | Spec. Code K01, P&G J |
| Extraction solvent: | 45/45/10 CHCl3/MeOH/UPW 1% HOAc |
| APPARATUS USED | |
| Mass Spectrometer | AB Sciex API4000 MS/MS, with Turbo IonSpray capability; |
| | or AB Sciex API3000 MS/MS |
| HPLC Pumping System | Shimadzu Prominence LC20A system UFLC |
| | (controller & 3 pumps) |
| HPLC Column | Waters, Atlantis HILIC Silica 5um, 2.1 × 50 mm column, Part |
| | No. 186002012 |
| Quantitative Program | Analyst/Multiquant |
| Loop Volume | 10 μL |
| Flow rate | 400 μL/min |
| Injection volume | 20 μL |
| HPLC Column Temperature | Room Temperature |

### Test Results:

The below table shows the actual amount of diesterquat (DEEDMAC) softening active deposited onto the fabrics, as well as the resulting coefficient of friction measured on the fabrics. It can clearly be seen that when formulating a cationic hydroxyethylcellulose according to the invention in the main wash product, that an enhanced diesterquat softening active (DEEDMAC) deposition in the rinse and hence improved softening performance (decreased coefficient of friction—KCoF) is achieved.

| | | | Deposited | | |
|---|---|---|---|---|---|
| | | Diesterquat | diesterquat | | |
| | CatHEC in | (DEEDMAC) | (DEEDMAC) | | |
| | main wash | in rinse | (Terry cotton) | KCoF | Delta KCoF |
| Comparative | — | — | — | 1.69 | — |
| Example A | | | | | |
| Comparative | 2 ppm | — | — | 1.68 | −0.01 |
| Example B | through | | | | |
| | the wash | | | | |
| Comparative | — | 43 ppm | 483 μg/g | 1.5 | — |
| Example C | | through the | | | |
| | | wash | | | |
| Example A | 2 ppm | 43 ppm | 675 μg/g | 1.36 | −0.14 |
| | through | through the | | | |
| | the wash | wash | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabrics comprising the steps of;
a. providing a water-soluble unit dose article, wherein the water-soluble unit dose article comprises a water-soluble film and a laundry detergent composition, wherein the laundry detergent composition comprises a non-soap anionic surfactant, a cationic polysaccharide polymer, and less than about 10% by weight of the laundry detergent composition of a fatty acid, a neutralised fatty acid soap or a mixture thereof,
wherein the laundry detergent composition further comprises between about 0% and about 5%, by weight of the liquid laundry detergent composition of a fatty alcohol ethoxylate non-ionic surfactant;
b. contacting the water-soluble unit dose article with sufficient water to dilute the laundry detergent composition by a factor of between about 300 and about 3000 fold to create a main wash liquor and contacting the fabrics to be laundered with the wash liquor;
c. washing the fabrics to be washed in the main wash liquor, and then separating the fabrics and said main wash liquor from one another;
d. providing a fabric softening composition, wherein the fabric softening composition comprises a softening active selected from the group consisting of quaternary ammonium compounds, amines, fatty esters, sucrose esters, silicones, dispersible polyolefins, polysaccharides, fatty acids, softening oils, polymer latexes, softening clays and combinations thereof,
e. contacting the fabric softening composition with sufficient water to dilute the fabric softening composition by a factor of between about 300 and about 3000 fold to create a rinse liquor and contacting the fabrics from step c with the rinse liquor;
f. rinsing the fabrics in the rinse liquor, and then separating the fabrics and said rinse liquor from one another; and
g. drying the fabrics.

2. The process according to claim 1 wherein the wash and rinse liquor independently comprise between 1 L and 64 L of water.

3. The process according to claim 2 wherein the wash and rinse liquor independently comprise between 2 L and 32 L of water.

4. The process according to claim 3 between 3 L and 20 L of water.

5. The process according to claim 1 wherein the main wash liquor is at a temperature of between about 5° C. and about 90° C.

6. The process according to claim 1 wherein washing the fabrics in the main wash liquor takes between about 5 minutes and about 50 minutes to complete.

7. The process according to claim 1 wherein the rinse liquor is at a temperature of between about 5° C. and about 30° C.

8. The process according to claim 1 wherein rinsing the fabrics in the rinse liquor takes between about 1 minute and about 30 minutes to complete.

9. The process according to claim 1 wherein the main wash liquor and the rinse liquor independently comprise between about 1 kg and about 20 kg of fabrics.

10. The process according to claim 1 wherein the laundry detergent composition comprises between about 0.05% and about 10% by weight of the laundry detergent composition of the cationic polysaccharide polymer.

11. The process according to claim 1 wherein the cationic polysaccharide polymer is selected from cationically modified hydroxyethyl cellulose, cationically modified hydroxypropyl cellulose, cationically and hydrophobically modified hydroxyethyl cellulose, cationically and hydrophobically modified hydroxypropyl cellulose, or a mixture thereof,

12. The process according to claim 11 wherein the cationic polysaccharide is in particulate form, and has an average D90 diameter of less than 300 microns.

13. The process according to claim 1 wherein the non-soap anionic surfactant comprises linear alkylbenzene sulphonate, alkoxylated alkyl sulphate or a mixture thereof.

14. The process according to claim 13 wherein the non-soap anionic surfactant comprises a mixture of linear alkylbenzene sulphonate and alkoxylated alkyl sulphate wherein the ratio of linear alkylbenzene sulphonate to alkoxylated alkyl sulphate is from about 1:2 to about 20:1.

15. The process according to claim 1 wherein the laundry detergent composition comprises up to about 50% by weight of the laundry detergent composition of the non-soap anionic surfactant.

16. The process according to claim 15, wherein the laundry detergent compositions comprises between about 5% and about 50%, by weight of the laundry detergent composition of the non-soap anionic surfactant.

17. The process according to claim 1 wherein the laundry detergent composition comprises less than about 8%, by weight of the laundry detergent composition of fatty acid, neutralised fatty acid soap or a mixture thereof.

18. The process according to claim 1 wherein the laundry detergent composition comprises between about 1% and about 5%, by weight of the liquid laundry detergent composition of a fatty alcohol ethoxylate non-ionic surfactant.

19. The process according to claim 1 wherein the softening composition comprises between about 2% and about 25% by weight of the softening composition of the softening active.

20. The process according to claim 1 wherein the fabrics comprise natural materials, synthetic materials or a mixture thereof.
